(19) United States
(12) Patent Application Publication
(10) Pub. No.: US 2026/0356862 A1
(43) Pub. Date: Nov. 12, 2026

(54) BISPHENOL-CYCLIC POLYMETHYLHYDROGENSILOXANE COMPOUND AND THE PREPARATION THEREOF

(71) Applicant: Dow Silicones Corporation, Midland, MI (US)

(72) Inventors: Eric Joffre, Shepherd, MI (US); Nanguo Liu, Midland, MI (US)

(21) Appl. No.: 19/487,199

(22) PCT Filed: Jul. 2, 2024
(86) PCT No.: PCT/US2024/036518

§ 371 Date: Nov. 24, 2025

Related U.S. Application Data
(60) Provisional application No. 63/512,713, filed on Jul. 10, 2023.
(60) Provisional application No. 63/513,185, filed on Jul. 12, 2023.

(51) Int. Cl. C07F 7/21

(52) U.S. Cl. CPC C07F 7/21

(57) ABSTRACT

The present invention is a compound of Formula 1: where each n is 1, 2, or 3. The compound of the present invention is useful as an adhesion promoter in thermally conductive compositions. The present invention is also a method of preparing the compound of Formula 1.

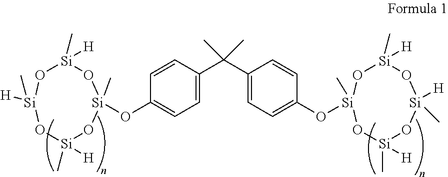

### BACKGROUND OF THE INVENTION

In recent years, efficient ways of adhering silicone rubber to incompatible materials such as organic resins have been described. For example, U.S. Pat. No. 6,887,932 discloses the preparation and use of cyclic polymethylhydrogensiloxanes containing a mono-, di-, or triphenylene skeleton not directly bonded to a silicon atom. Examples of such compounds include BPA derivatives bonded to terminal cyclic polymethylhydrogensiloxanes groups through propoxyl linking groups, as illustrated:

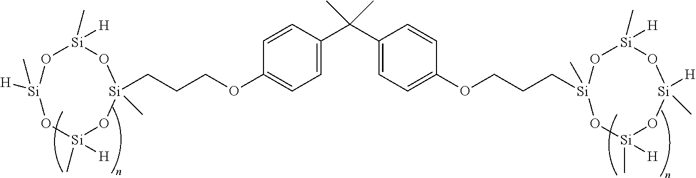

where n is 1, 2, 3, or 4.

Unfortunately, the preparation of such adhesion promoters leads to the formation of a significant amount of the following by-product terminated with only one D^{H}₄ group:

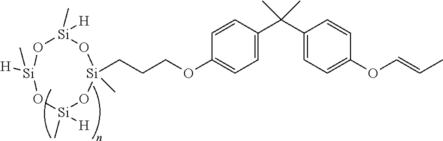

Moreover, the preparation of such adhesion promoters requires the use of a Pt catalyst, which is difficult to remove, thereby adversely impacting shelf-life in Part B addition cure formulations. Accordingly, there is a need to discover a reactive adhesion promoter that can be prepared in high yield and purity without a Pt catalyst.

### SUMMARY OF THE INVENTION

The present invention addresses a need in the art by providing, in one aspect, a compound of Formula 1:

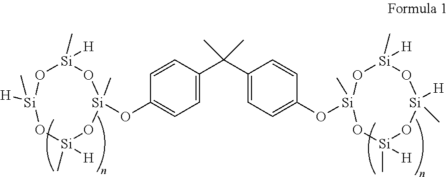

where each n is 1, 2, or 3. The compound of the present invention, which can be prepared in high purity and yield and without a platinum catalyst, is useful as an adhesion promoter in thermally conductive compositions.

### DETAILED DESCRIPTION OF THE INVENTION

The present invention is a compound of Formula 1:

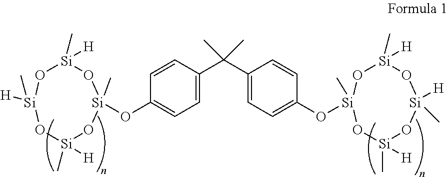

where each n is 1, 2, or 3.

The compound of Formula 1 can be prepared in a single step by dehydrogenative condensation of bisphenol A and a cyclic polymethylhydrogensiloxane of Formula 2 in the presence of a catalytic amount of a Lewis acid such as tris(pentafluorophenyl) borane (BCF):

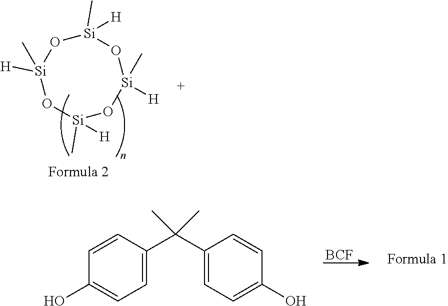

The temperature of the reaction is preferably controlled in the range of 20 °C to 40 °C. The BCF catalyst can readily be removed by treatment with Al₂O₃, or completely deactivated at 100 °C for 10 minutes. The compound of the present invention does not require a platinum catalyst, which is a significant advantage for the reasons described above.

The compound of Formula 1 is useful as an adhesion promoter in a thermally conductive composition. Accordingly, in another aspect, the present invention is a composition comprising a) the compound of Formula 1, b) a divinyl-terminated poly(di-C₁-C₆-alkyl) siloxane, preferably a divinyl-terminated polydimethylsiloxane, with a degree of polymerization (dp) in the range of from 8 or from 20 or from 100, to 600 or to 300; c) an organohydrogenpolysiloxane (Si—H containing polysiloxane) having a dp preferably of from 10 to 100; d) thermally conductive filler particles such as alumina or zinc oxide particles; e) a first filler treating agent which is a trimethoxysilyl-terminated polydimethylsiloxane (PDMS) having a dp preferably in the range of from 10 to 150; f) a second filler treating agent which is a C₆-C₂₀-alkyltrimethoxysilane such as n-decyltrimethoxysilane; and g) a platinum catalyst. The composition may further contain an inhibitor for the platinum catalyst such as phenylbutynol, and a pigment such as STAN-TONE 40SP03 Blue pigment.

The concentration of the thermally conductive filler particles is preferably in the range of from 1000 or from 1200 parts by weight (pbw) to 1600 or to 1450 pbw per 100 pbw of the divinyl-terminated poly(di-C₁-C₆-alkyl) siloxane. The thermally conductive filler particles are preferably present in the composition as a multimodal distribution of alumina or zinc oxide particles, or both, having D₅₀ particle sizes in the range of from 200 nm to 800 nm; from 1 μm to 10 μm; and from 20 μm to 100 μm, as measured by laser diffraction.

The concentration of the first and second filler treating agents is preferably in the range of from 0.5 to 3 pbw per 100 pbw of the thermally conductive filler particles. The ratio of Si—H groups in the organohydrogenpolysiloxane to vinyl groups of the divinyl-terminated poly(di-C₁-C₆-alkyl) siloxane is preferably in the range of from 0.5:1 to 1.1:1, and the concentration of the ratio Si—H groups in the organohydrogenpolysiloxane to the Si—H groups in the compound of Formula 1 is preferably in the range of from 0.1:1 to 1:1.

### EXAMPLES

### Example 1—Preparation of a Compound of Formula 1 (n=1)

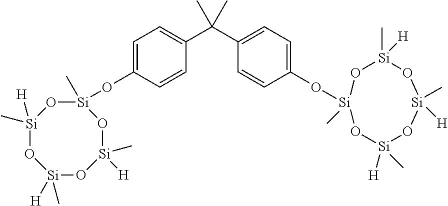 [SMILES: C[SiH]1O[SiH](C)O[Si](C)(Oc2ccc(C(C)(C)c3ccc(O[Si]4(C)O[SiH](C)O[SiH](C)O[SiH](C)O4)cc3)cc2)O[SiH](C)O1]

Bisphenol A (BPA, 100.3 g), anhydrous toluene (295.2 g, ACS grade), heptane (77.0 g), and 809 g D^{H}₄ (809 g, available from Gelest) were charged into a 2-L flask. Residual water (from D^{H}₄) was removed by distillation of solvents and re-charging anhydrous toluene (160.0 g) back into the flask. The mixture was stirred overnight, and tris(pentafluorophenyl) borane/toluene catalyst (248 μL of 4.46% BCF) was added into the flask. The pot temperature was controlled in the range of 22 °C to 38 °C using a dry ice cooled heating block, and stirring was continued for 3 h, 50 min. Al₂O₃ (23 g) was then added to the flask to remove the BCF. Stirring was continued for another 1.5 h, after which time the contents of the flask were filtered through a 0.45-μm membrane. Residual volatiles were removed at 1 torr and 60 °C for 50 min to obtain the desired product (278.0 g). Structure was confirmed by ¹H, ¹³C, and ²⁹Si NMR spectroscopy.

### Example 2—Preparation of a Compound of Formula 1 (n=1, 2, and 3)

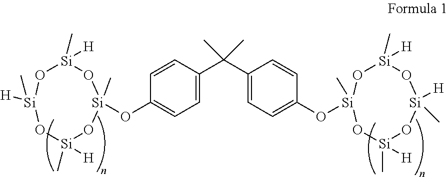

BPA (104.3 g), anhydrous toluene (494.5 g, ACS grade), and DOWSIL™ MH-1109 Fluid (791.2 g, A Trademark of The Dow Chemical Company or Its Affiliates) were charged into a 2-L flask equipped with a thermocouple, a mechanical stirrer, and an adapter to an N₂ bubbler. The headspace of the flask was purged with N₂ for 5 min, after which time a BCF/toluene catalyst (199 μL of 4.46% BCF) was added into the flask. The pot temperature was controlled in the range of 22 °C to 30 °C using a dry ice cooled heating block. Gas evolved during this time, and when the evolution subsided, an additional amount of the BCF/toluene catalyst (57 μL) was added and repeated 5 times. The contents of the flask were stirred for an additional 3 h, after which time Al₂O₃ (47 g) was added. Stirring was continued for another 2 h, after which time the contents of the flask were filtered through a 0.45-μm membrane. Residual volatiles were removed at 1 torr and 60 °C for 50 min to obtain the desired product (438.6 g). Structure was confirmed by ¹H, ¹³C, and ²⁹Si NMR spectroscopy.

### Example 3—Preparation of a Thermally Conductive Compound

Vinyl-terminated polydimethylsiloxane (60 mPa·s, 6.5 pbw), trimethoxysiloxy-terminated polydimethylsiloxane (dp=30; 0.7 pbw), and n-decyltrimethoxysilane (0.2 pbw) were loaded into a 1-L planetary mixer followed by addition of AES-12 alumina (18.8 pbw) and AL-M734 alumina (20.8 pbw). The mixture was stirred at room temperature for 10 min, after which time DAM-40K alumina particles (25 pbw) were added. Stirring was continued for 10 min, whereupon additional amount of DAM-40K alumina particles (25 pbw) were added. Stirring was continued for another 10 min, followed by scraping and further mixing for an additional 10 min. The contents were heated at 160 C in vacuo for 60 min, then cooled to room temperature for 30 min. STAN-TONE 40SP03 Blue (0.2 pbw), SiH terminated polyorganosiloxane (dp=14, 2.62 pbw), the compound of Formula 1, Example 2 (0.06 pbw), and phenylbutynol (0.01 pbw) were added to the mixer and mixing was continued for 15 min, followed by scraping and further mixing in vacuo for an additional 15 min. The contents of the mixer were removed; Platinum 85 catalyst (0.1 pbw, 6000 ppm Pt) was then added to the mixture.

### Measurement of Hardness

A mold having plate dimensions of 120 mm×120 mm×2 mm was used with a PTFE sheet between each plate of the mold. The composition was disposed in the mold to form a sheet having a thickness of 2 mm, and cured in a hot press for 60 min at 120 °C, followed by measuring JIS TYPE A hardness with the JIS TYPE A hardness tester. Hardness was measured by stacking three sheets on top of one another. Hardness was also measured after aging each thermally conductive member for 72 h at 200 °C.

### Thermal Conductivity (Hot Disk)

A test piece of the thermally conductive sample was prepared in a mold having plate dimensions of 5 0 mm×30 mm×6 mm with a PTFE sheet between each plate of the mold. Each composition was disposed in the mold to form a sheet having a thickness of 6 mm, and cured in a hot press for 60 min at 120 °C. The sheet was removed from the mold and stored for 24 h at 25°, after which time a Hot Disk TPS 500S from Hot Disk AB of Goteborg, Sweden was used to measure thermal conductivity of two samples, which was averaged.

### Lap Shear Strength and Cohesive Failure Ratio

Adhesion strength (MPa) and cohesive failure ratio (%) of each thermally conductive member was measured by first cleaning aluminum diecasting substrates (ADC12) with isopropyl alcohol. The composition was filled into an overlap area defined by the aluminum diecasting substrates having dimensions of 10 mm×24 mm×1 mm. The composition was cured in a hot press for 60 min at 120 °C while disposed in the overlap area defined by the substrates. After curing, excess cured product was removed from the perimeter of the overlap area via a cutter, and properties were measured via a tensile testing with a measuring speed of 50 mm/min.

Table 1 summarizes the hardness, adhesion strength, and cohesive failure ratio for the Example 3 composition.

TABLE 1
Properties of Example 3 Composition

| | |
|---|---|
| Hardness (JIS Type A) | 31 |
| Hardness after 72 h @ 200 °C | 49 |
| Thermal Conductivity (W/m · K) | 3 |
| Adhesion strength (MPa) | 0.4 |
| Cohesive Failure (%) | 100 |

1. A compound of Formula 1: 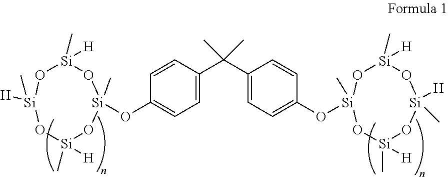
where each n is 1, 2, or 3.

2. The compound of Formula I where each n is 1.

3. A method comprising the step of contacting bisphenol A and a compound of Formula 2 in the presence of a Lewis acid catalyst under such conditions to form a compound of Formula 1, wherein the compound of Formula 2 is represented by the following structure: 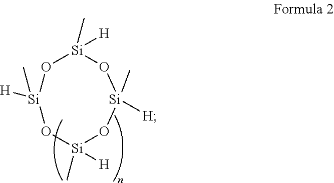
and wherein the compound of Formula 1 is represented by the following structure: 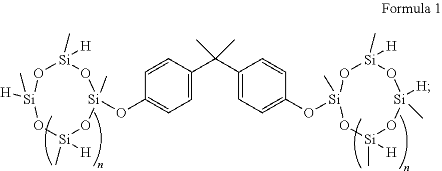
where each n is 1, 2, or 3.

4. The method of claim 3 wherein the Lewis acid catalyst is tris(pentafluorophenyl) borane and the reaction temperature is maintained at a temperature in the range of from 20 °C to 40 °C.

5. The method claim 4 where each n is 1.
